(19) United States
(12) Patent Application Publication
(10) Pub. No.: US 2005/0207569 A1
(43) Pub. Date: Sep. 22, 2005

(54) Methods and apparatus for preparing data for encrypted transmission

(75) Inventors: Ji Zhang, Monte Sereno, CA (US); Hain-Ching Liu, Fremont, CA (US); Jian Gang Ding, San Jose, CA (US)

Correspondence Address: IRENE HU, 2033 RALSTON AVE., PMB 146, BELMONT, CA, 94002, US

(73) Assignee: Exavio, Inc, Santa Clara, CA (US)

(21) Appl. No.: 11/016,479

(22) Filed: Dec. 16, 2004

Related U.S. Application Data
(60) Provisional application No. 60/553,933, filed on Mar. 16, 2004.

(51) Int. Cl. H04L 9/00

(52) U.S. Cl. 380/28

(57) ABSTRACT

Methods and apparatus for preparing data for encrypted transmission. According to the current invention, a data bitstream may be processed to create side information. After extracting, generating and/or acquiring the side data, some or all of the data bitstream may be encrypted and then combined to create a combined data bitstream, ready for transmission. Subsequently, the combined data bitstream may be transmitted over a network. By processing a data bitstream to extract metadata about the bitstream before encrypting the data, some processing such as splicing, bit rate switching and/or statistical multiplexing done after encryption may be executed without requiring costly de-encryption/re-encryption steps based, in part, on inspecting the contents of the side data. The bitstream may represent video, audio, image or other data types. In some examples according to the current invention, a combined data bitstream may comprise multiple bitstreams, each at a different bit rate.

### REFERENCE TO PRIOR APPLICATION

This application claims the benefit under 35 U.S.C. § 119(e) of U.S. Provisional Patent Application No. 60/553,933 filed on Mar. 16, 2004, entitled “Methods for Transmitting Pre-Encrypted Data,” which is incorporated by reference herein in its entirety. This application also relates to U.S. patent application Ser. No. 10/633,111 filed on Aug. 1, 2003, entitled “Statistical Remultiplexing of Compressed Video Segments”, which is incorporated by reference herein in its entirety.

### FIELD OF INVENTION

Invention relates to apparatus and methods for preparing data for encrypted transmission.

### BACKGROUND OF INVENTION

Encryption technology enables the secure transmission of data streams such as digital video data and multimedia content. Using a conditional access business model, some service providers, such as subscription cable companies, may encrypt or scramble copyrighted content, transmit that content to a subscriber and then enable the subscriber to decrypt or unscramble the received content. However, once encrypted, it may be difficult for the subscription cable company to perform additional processing on the data stream. For example, when operating on an encrypted data stream, altering a bit rate to support full bandwidth utilization and/or splicing content streams may require additional decryption and re-encryption steps, thereby introducing added expense and delay.

What is needed is an efficient way to prepare data for secure transport over a network while flexibly supporting the ability to perform additional processing on the data stream. In some cases it would be useful for the method and system to support high throughput, provide good security and operate with compressed and/or uncompressed data.

### SUMMARY OF INVENTION

The present invention provides apparatus and methods for preparing data for encrypted transmission. According to the current invention, a data bitstream may be processed to create side information. For example, when the data bitstream is a video feed comprised of video segments, the side information may describe one or more of the following features: the video block segment layout, video block segment offset information, video block segment length data, video block length, video block segment bit rate, video block segment usage value, video block segment compression statistics, video block segment look-ahead packet schedule information, video block segment timestamps, indexing metadata and content management metadata. After extracting, generating and/or acquiring the side data, some or all of the data bitstream may be encrypted. The encrypted data bitstream and the side data may then be combined to create a combined data bitstream, ready for transmission. Subsequently, the combined data bitstream may be transmitted over a network. By processing a data bitstream to extract metadata about the bitstream before encrypting the data, some processing done after encryption may be executed without requiring costly de-encryption/re-encryption steps. In some cases, the side information may comprise metadata related to the content of the data bitstream, extracted or calculated parameters and/or information that may be used in subsequent processing steps.

In some examples according to the current invention, the data bitstream may be received as an uncompressed, partially or completely encoded and/or compressed bitstream. The bitstream may represent video, audio, image or other data types. A received bitstream may be transcoded to another compression format and/or the data bitstream may be compressed prior to encryption. Furthermore, in some examples, the combined data bitstream may be partially or completely encoded and/or compressed after encryption in preparation for transmission.

In some examples according to the current invention, a combined data bitstream may comprise multiple bitstreams, each at a different bit rate. In some cases, subsequent processing such as splicing, bit rate switching and/or statistical multiplexing (or statmuxing) may be executed without requiring decryption of the combined data bitstreams based, in part, on inspecting the contents of the side data.

### BRIEF DESCRIPTION OF DRAWINGS

FIG. 1 illustrates an example of a system for preparing data for encrypted transmission according to the current invention.

FIG. 2 illustrates an example of a staging processor.

FIG. 3 illustrates an example of a video segment transration architecture for creating multiple output data segments at different bit rates.

FIG. 4 illustrates an example of a relationship between a video segment, a transprocessor performing transration and a formatter.

FIGS. 5a, b and c illustrate examples of video block structures associated with a transrated video bitstream.

FIG. 6 illustrates an example of an application of the current invention in a video distribution network.

FIG. 7 illustrates block diagram of an example process for preparing data for encrypted transmission.

FIG. 8 illustrates a block diagram of an example process for bit rate based processing of encrypted pre-processed data.

### DETAILED DESCRIPTION OF PREFERRED EMBODIMENTS

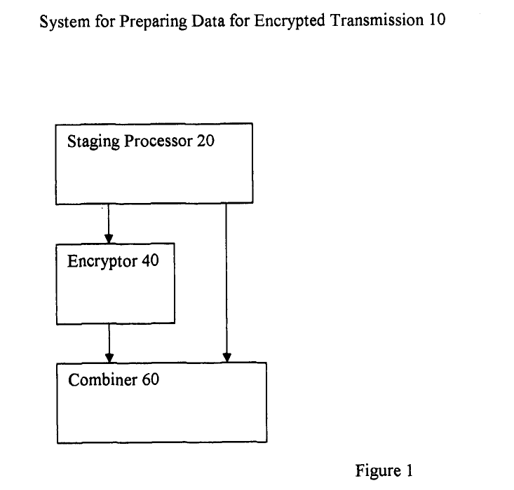

FIG. 1 illustrates an example of a system for preparing data for encrypted transmission 10 according to the current invention. In this example, the system 10 comprises a staging processor 20, an encryptor 40 and a combiner 60. According to the current invention, the staging processor 10 receives a data bitstream from an ingest source and processes the data bitstream to generate two portions: side data and content. In some cases, the two portions comprise a structured bitstream. The encryptor 40 may encrypt and/or encode some or all of the content. The combiner 60 combines the partially or completely encrypted and/or encoded content and the side data to generate a combined bitstream in preparation for transfer or transmission.

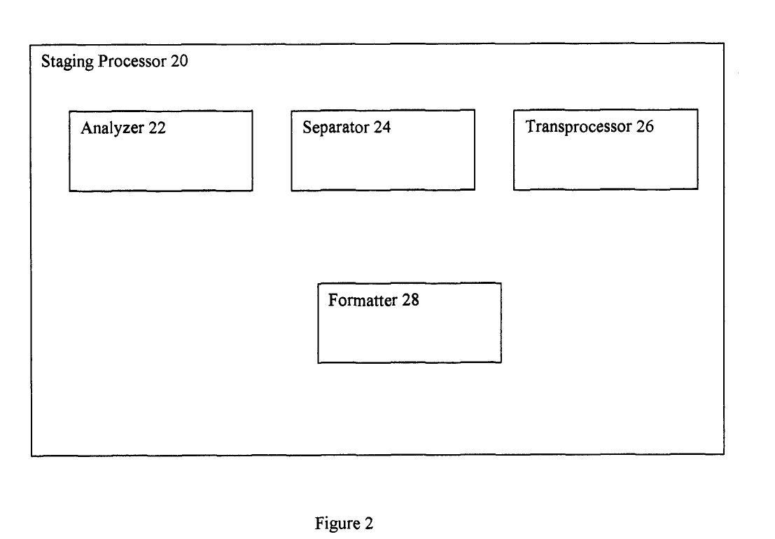

FIG. 2 illustrates an example of a staging processor 20. In this example, the staging processor comprises an analyzer 22, a separator 24, a transprocessor 26 and a formatter 28. The staging processor 20 may receive a data bitstream from an ingest source such as, but not limited to, a real-time encoder or a downlink receiver. In this example, the received data bitstream is a compressed video feed. However, in other examples according to the current invention, the received bitstream may be uncompressed or partially or completely encoded or compressed and may represent data such as, but not limited to: audio data, audio video data, video data and/or multimedia data.

According to an example of the current invention as illustrated in FIG. 2, an analyzer 22 may analyze, calculate, generate, access or extract side information from an input data bitstream; in some cases, this side information may be used to support future processing. In this example, the data bitstream is an MPEG-2 (version 2 of the standard from the Moving Picture Experts Group (MPEG) from the ISO/IEC (International Standards Organisation International Electrotechnical Commission))) format transport stream. However, other formats may be used such as, but not limited to: MPEG-1 (version 1 of the standard from the MPEG from the ISO/IEC), MPEG4 (version 4 of the standard from the MPEG from the ISO/IEC) and H.264/AVC (Advanced Video Coding High Compression Standard from the Joint Video Team (JVT) a collective effort from International Telecommunication Union Coding Experts Group (VCEG) together with the MPEG from ISO/IEC). In this example, analyzer 22 may extract, access or identify one or more of the following pieces of side data: PCR (Program Check Reference), PTS (Presentation Time Stamp)/DTS (Decoding Time Stamp), picture coding type, size of the coded picture in bytes, average quantization scale, average motion vector size, number of bits used by DCT (Discrete Cosine Transform) coefficients per coded picture, number of coded pictures before the next intra coded picture, packet schedule profile, statistics of the compressed video program streams, the video block segment layout, video block segment offset information, video block segment length data, overall video block length, video block segment bit rate, video block segment usage value, video block segment compression statistics, video block segment look-ahead packet schedule information, video block segment timestamps, the total number of video segments in a video block, indexing metadata and content management metadata.

Look-ahead packet schedule information may include key statistics for video blocks that occurs ‘ahead’ in time of the current video block. A look-ahead window may be one or more blocks of video data packets. In some cases, look-ahead information may be used by additional following steps to determine which of the video segment is to be used for the multiplexing in order to result in better bandwidth efficiency.

In some cases, some or all of the side data may be generated, calculated and/or retrieved from other sources. In some cases, the side data may be content related; for example, where the data bitstream may represent a movie, the side data may comprise information such as the list of actors, which may or may not be extracted from the data bitstream. In some cases, the side data may be extracted and/or calculated. For example, the side data may comprise metadata related to indexing for VCR (Video Cassette Recorder) controls and content management which may be generated, calculated and/or retrieved. In other examples according to the current invention, the format of the bitstream may be another format such as, but not limited to: MPEG-1, MPEG-2, MPEG-4, H.264, Real, Quicktime and Microsoft Windows Media format. Depending on the nature of the data bitstream and/or the format, the analyzer may access, calculate, and/or generate different or additional side data.

In this example, the separator 24 has access to the output of the analyzer 22 and performs segmentation of the data bitstream. Specifically, in this example, the separator 24 performs segmentation of a compressed video bitstream into video segments for the purpose of facilitating subsequent processing steps such as, but not limited to, bit rate switching, splicing, digital video splicing, stream switching, digital advertisement insertion, fast-forward, fast-rewind and statistical multiplexing/remultiplexing. In this example, the separator 24 segments the data bitstream into video segments so that they may be treated as self-contained data units in such a way that subsequent processes may be individually process the video segments to create video segments of different bit rates.

However, in other examples according to the current invention, different segmentation may be executed and/or different subsequent processing steps may be applied. In this example using a compressed video bitstream, the separator 24 may extract the elementary payload from the input bitstream and partition the resulting payload into separate data units. For example, the elementary stream (ES) payload may be partitioned along coded pictures and/or group of coded pictures (GOP) boundaries, thereby creating partitions or segments of frames such as video segments (video segment). Each video segment may represent a collection of video coded pictures that may be processed as a unit in subsequent stages. Depending on the processing capability and requirement, video segments may be a GOP or simply a coded picture of I (intra coded), P (forward predicted) or B (bi-directional) type. In some cases, separator 24 may be configurable. For example, a separator 24 may be configured to produce video segments of a particular size; in some cases, it may be useful to configure a video segment size based in part on the granularity required by a downstream bit rate switch. In some cases, the separator 24 may analyze the bit rate characteristics of one or more video segments. For example, the separator 24 may determine the size of a video segment, timing information such as PCR/PTS/DTS related to a segment and/or bit rate information.

In this example a transprocessor 26 may access the output of the separator 24 and optionally perform subsequent processing. In some cases, the video segment output of the separator 24 may have a low bit rate and the transprocessor 26 may be configured to direct the output of the separator to the formatter 28 without altering the bit rate. In other examples, transprocessor 26 may provide a single Constant Bit Rate (CBR) output at a configured bit rate that may be higher or lower than the bit rate of the separator 24 output. However, in other examples, a transprocessor 26 may perform bit rate reduction. In this example, the video segments generated by the separator 24 were compressed, so the bit rate reduction is a transrating process. However, in other examples according to the current invention, the video segments generated by the transprocessor 26 may or may not be compressed or encoded. In some cases, the bit rate reduction may be a re-quantization process if the video segment is of compressed format.

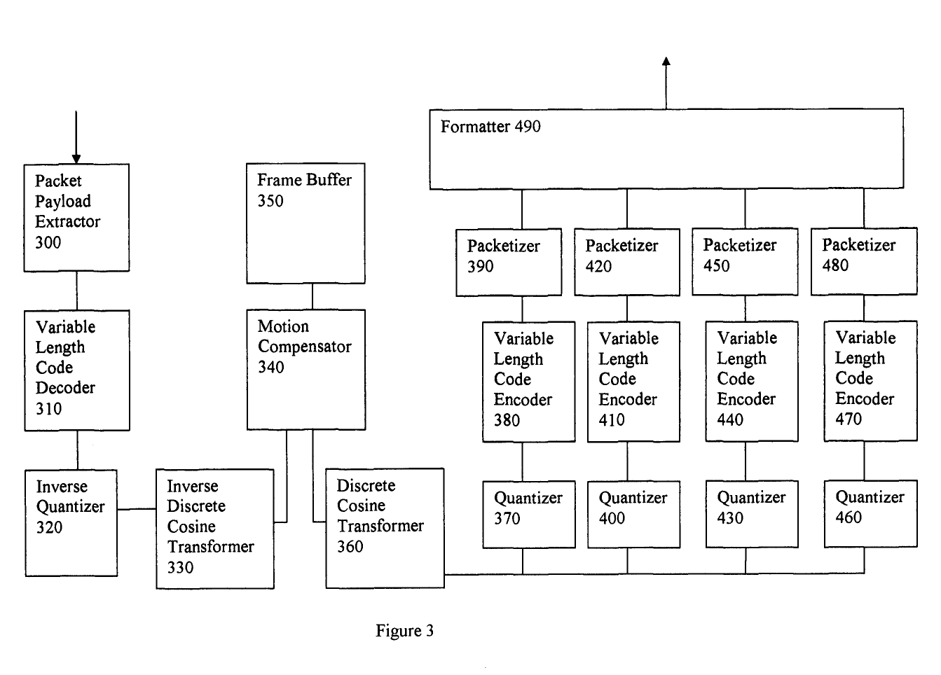

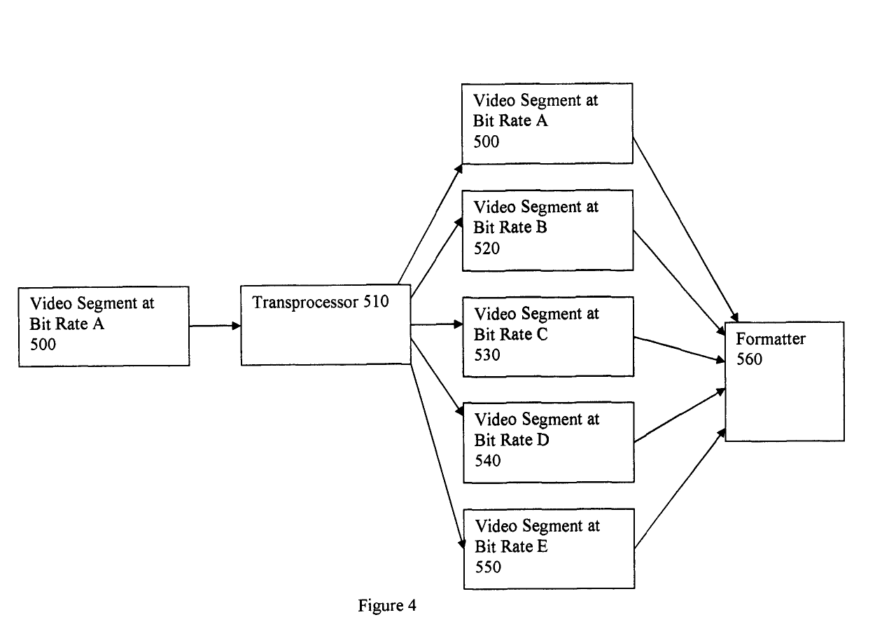

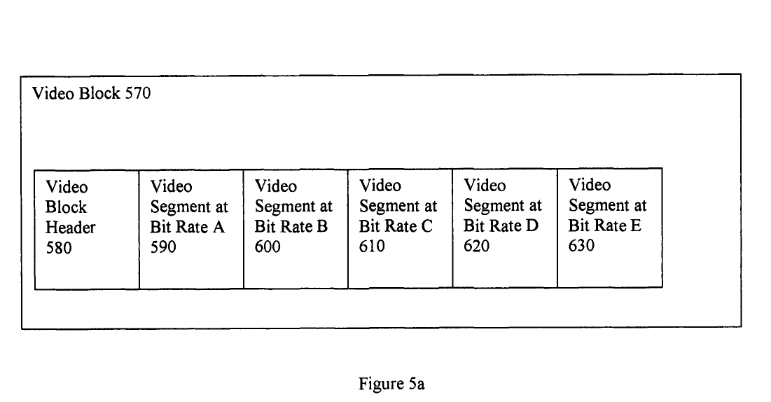

FIG. 3 illustrates an example of a video segment transration architecture for creating multiple output data segments at different bit rates. By providing multiple output data segments at different bit rates, a downstream bit rate switch may operate without requiring potentially costly and/or time-consuming decryption/re-encryption steps and decode/encode steps. In this example, compressed video segments are pre-conditioned to simplify later stage processing such as splicing and/or statistical remultiplexing. FIG. 4 illustrates an example of a relationship between a video segment, a transprocessor performing transration and a formatter. In this example a compressed video segment at a bit rate “A” 500 is submitted to the transprocessor 510. This transprocessor transrates video segment 500, producing four compressed video segments 520, 530, 540 and 550, wherein each video segment may have a different bit rate. The video segments are subsequently submitted to the formatter 560 for formatting. Similarly, this type of pre-processing may be used to support downstream statistical multiplexing operations, thereby enabling efficient and flexible utilization of overall channel bandwidths without requiring potentially costly and/or time-consuming decryption/re-encryption steps and decode/encode steps.

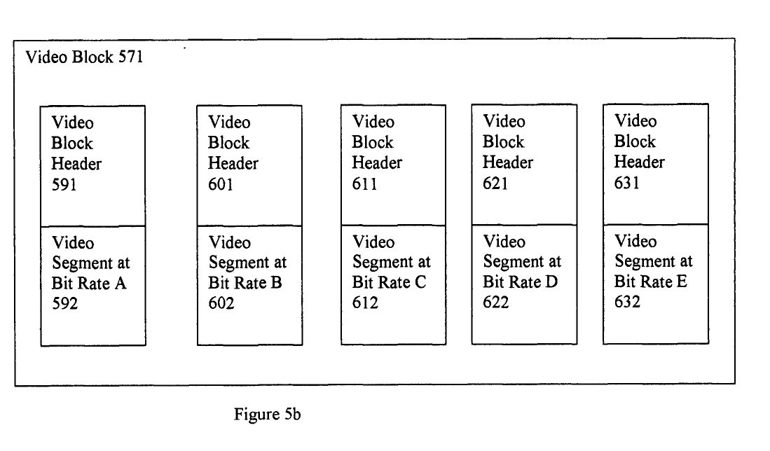

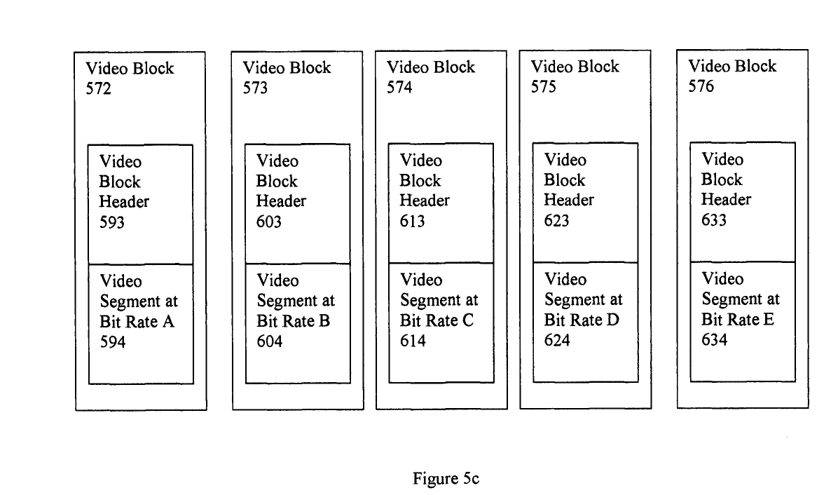

In one embodiment, the formatter 28 may receive an input bit stream and format the input bit stream into one or more transport packets. For example, the separator 24 and the transprocessor 26 may output MPEG-2 elementary stream packets. The formatter 28 may configure the MPEG-2 elementary stream packets into an MPEG-2 transport stream packet structure. FIGS. 5a, b and c illustrate examples of video block structures associated with a transrated video bitstream. In example 5a, each video block comprises a video block header 580 and a set of video segments 590, 600, 610, 620 and 630. In this example, the formatter may format an input bitstream into transport packets representing the video block header 580 and video segments 590, 600, 610, 620 and 630. In this example, video block header 580 holds side information or metadata about the subsequent video segments 590, 600, 610, 620 and 630. In this example, a single video block header 580 may be packetized into one or more packets and formatted with multiple packetized video segments 590, 600, 610, 620 and 630, each video segment at a different bit rate.

In example 5b, video block 571 comprises multiple video block headers 591, 601, 611, 621 and 631 and a set of corresponding video segments 592, 602, 612, 622 and 632, each video segment at a different bit rate. In this example, each video segment has a corresponding video block header. In example 5c, video blocks 572, 573, 574, 575 and 576 each comprise a single video block header and a single video segment. In other examples, a formatter may format a video block into transport packets such that a single video header is represented in one or more packets and formatted with one or more packetized video segments wherein each video segment is at the same bit rate. Note that in some cases, a single video block header may be packetized into multiple packets; for example, large video block headers may be broken up into multiple packets. However, in some cases, multiple smaller video block headers may be packetized into the same packet.

In this example, the output of the staging processor 20 is provided to an encryptor 40. In this example, the encryptor 40 is a selective encryptor which selectively encrypts only the video data packets, creating an encrypted data bitstream, and does not encrypt packets holding metadata or side data. This strategy may be useful for preparing copyrightable data for secure transmission. Furthermore, information in the unencrypted metadata packets may be used to assist in some later stage processing on the encrypted data bitstream without requiring decryption. For example, metadata describing coded picture types (I, P or B type) may be maintained in unencrypted side data packets enabling the identification of coded picture types associated with packets in the encrypted data bitstream without requiring decryption of the encrypted data bitstream. However, in some examples according to the current invention, some or all of the data packets may be encrypted. In another example according to the current invention, some or all of the packets holding metadata or side data may be encrypted. In this example, the encryptor 40 scrambles the video data packets so that the resulting data can not be decoded and displayed without proper authentication process. The current invention may be used with a variety of available security and/or encryption schemes.

In this example, the combiner 60 combines partially or completely encrypted data packets with partially or completely encrypted or unencrypted side information packets into a single data packet stream. In this example, the combiner 60 combines the encrypted packets output by the encryptor 40 with the side data packets, aligning the unencrypted video block header packets with encrypted video segment packets.

The current invention may also be used in conjunction with later stage processing such as statistical remultiplexing, switching, digital bitstream splicing. These processes may also benefit from selective encryption. For example, statistical remultiplexing processes may make use of the packets holding side information and/or metadata to determine statistical multiplexing schedules. For example, some packets may hold video header fields. Some video header data fields may be used to determine the bit rate allocations for statistical multiplexing with requiring the decryption and re-encryption of the encrypted video data segments. In some cases, substantial computational savings may be achieved and exposure of copyrighted content may be minimized. However, even in examples where side data such as video header data fields are partially or completely encrypted, savings may be realized because only the side data packets would require decryption and re-encryption.

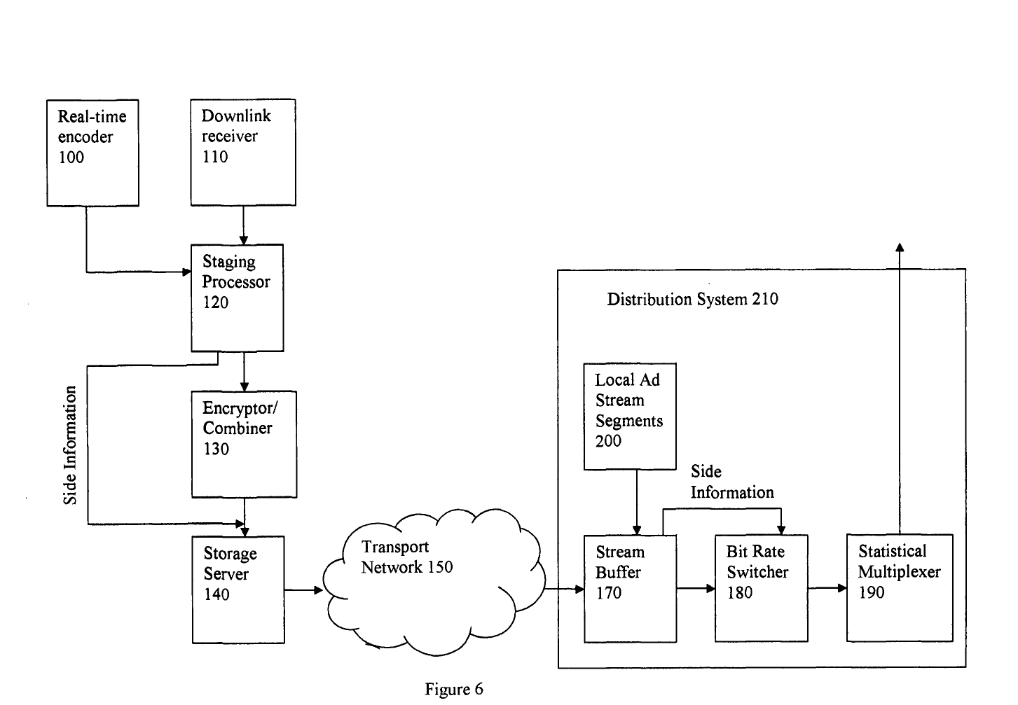

FIG. 6 illustrates an example of an application of the current invention in a video distribution network. In this example, an incoming unencrypted, compressed video bitstream representing protected material is received form a real-time encoder 100 and/or a downlink receiver 110. In this case, the protected material is copyrighted material and the current invention is used as an element in a digital rights management (DRM) methodology. However, the current application may be used when securely handling copyrighted and/or non-copyrighted sensitive or proprietary data. Staging processor 120 analyzes the compressed video bitstream, calculating, extracting and/or generating meta-data or side data relevant to the compressed video bitstream. The compressed video bitstream is segmented, processed and analyzed, producing compressed video segments representing the copyrightable material that may be treated as self-contained data units in downstream bit rate switching and/or statistical multiplexing operations. The compressed video segments are transrated. However, unlike some other transration processes where a single input compressed video segment is transrated to produce a single compressed output segment at a bit rate different from the input compressed video segment, the transration process used in this example takes a single input compressed video segment and creates multiple compressed output video segments, each at a different bit rate. These compressed output video segments are formatted into video blocks wherein each video block has a video block header holding side data, and multiple compressed video segments holding copyrightable video data. Subsequently, encryptor/combiner 130 performs selective encryption, encrypting the compressed video segments representing the copyrightable material but not the video block headers holding the side data. The encryptor/combiner 130 subsequently aligns the video block header packets with the compressed encrypted video segment packets and transmits the aligned packet stream. In this example, the aligned packet stream is transmitted to a storage server 140 for subsequent transmission to a distribution system 210 over a network 150. However, in other examples, the aligned packet stream may be transmitted directly to a distribution system from the encryptor/combiner without ever being stored in a storage server. In the distribution system 210, other segments such as, but not limited to, local advertising stream segments may be spliced with the compressed encrypted video packet stream by a bit rate switcher 180 based on the side-data in the video block headers and the availability of pre-processed compressed and encrypted video segments at various bit rates; in this example, decryption/re-encryption and decompression/recompression are not required. The spliced video packet stream may then be submitted to a statistical multiplexer which may operate without requiring decryption/re-encryption or decompression/recompression of the copyrightable material based on the side data and the availability of pre-processed compressed and encrypted video segments at various bit rates.

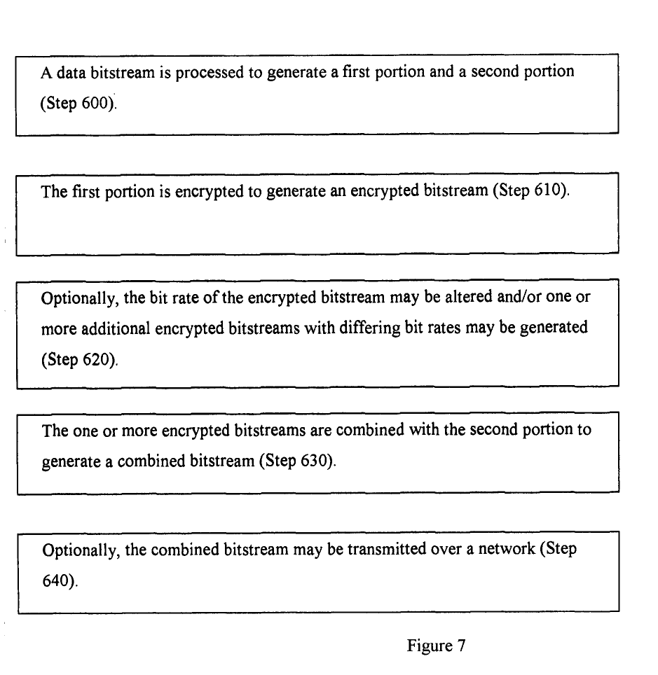

FIG. 7 illustrates block diagram of an example process for preparing data for encrypted transmission. The process begins when a data bitstream is processed to generate a first portion and a second portion (Step 600). The first portion is encrypted to generate an encrypted bitstream (Step 610). Optionally, the bit rate of the encrypted bitstream may be altered and/or one or more additional encrypted bitstreams with differing bit rates may be generated (Step 620). The one or more encrypted bitstreams are combined with the second portion to generate a combined bitstream (Step 630). Optionally, the combined bitstream may be transmitted over a network (Step 640).

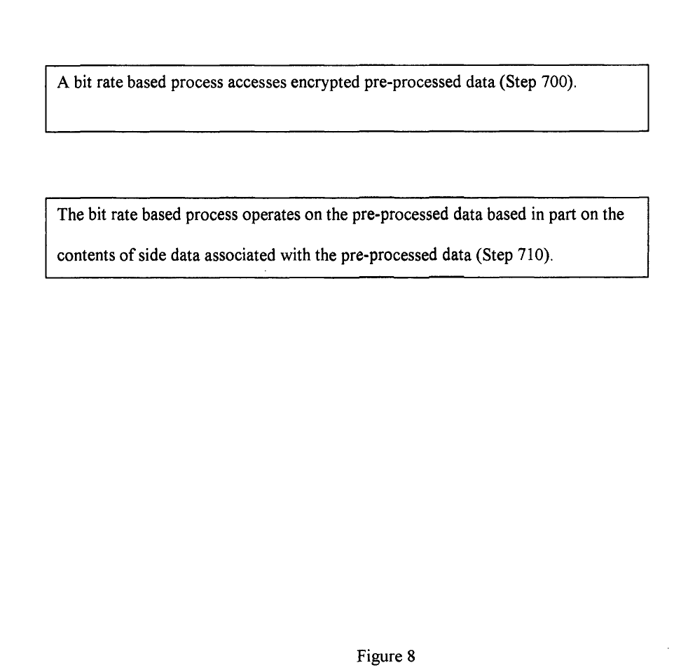

FIG. 8 illustrates a block diagram of an example process for bit rate based processing of encrypted pre-processed data. The process begins when a bit rate based process accesses encrypted pre-processed data (Step 700). The encrypted pre-processed data is a combined data stream representing encrypted data at multiple bit rates and associated side data. Some or all of the combined data stream may be compressed or uncompressed; the side data may be encrypted or unencrypted. Examples of bit rate processes include, but are not limited to bit rate switching, splicing, digital video splicing, stream switching, digital advertisement insertion, fast-forward, fast-rewind and statistical multiplexing/remultiplexing. The process continues when the bit rate based process operates on the pre-processed data based in part on the contents of side data associated with the pre-processed data (Step 710). According to the current invention, bit rate processes may be accomplished with encrypted pre-processed data without requiring decompression/compression or decryption/re-encryption of the data. However, if the side data is encrypted and/or compressed, decompression/compress and/or decryption/re-encryption of the side data may be required. Furthermore, because the pre-processed data provides data at different bit rates, bit rate reduction, transration and/or re-quantization are not required. For example, statistical remultiplexing processes may support high bandwidth utilization by switching the bit rate of encrypted pre-processed data streams. According to the current invention, the statistical multiplexing process may extract data or a specific bit rate from the encrypted pre-processed data based at least in part on the metadata associated with the encrypted pre-processed data without requiring decompression/compression or decryption/re-encryption. In some cases, a bit rate process may use one or more additional data streams. For example, audio video splicing processes may use side data stored in a video block header for splicing without requiring decryption of the encrypted pre-processed data. For example, the presentation time stamps (PTS) may be stored in a video block header representing the metadata associated with encrypted pre-processed video blocks. By inspecting video block headers for the PTS, the audio video synchronization may be executed without requiring decryption and/or decompression of the video blocks.

The examples of the current invention described above may be variously implemented in hardware, software and/or firmware. In some cases, systems according to the current invention may be distributed. In some cases, the flow of data through the current invention has been described as “input” to a particular module or “output” from a module. Other examples according to the current invention may operate using buffers or storage areas. In some cases, the data may not necessarily be “input” or “output”, but rather data in a buffer or storage area may be accessed, altered, copied and/or moved by various modules.

Foregoing descriptions of specific embodiments of the invention have been presented for purposes of illustration and description. They are not intended to be exhaustive or to limit the invention to the precise forms disclosed. Modifications and variations are possible in light of the above teaching.

The embodiments were chosen and described in order to explain the principles and the application of the invention, thereby enabling others skilled in the art to utilize the invention in its various embodiments and modifications according to the particular purpose contemplated. The scope of the invention is intended to be defined by the claims appended hereto and their equivalents.

1. An apparatus for preparing data for encrypted transmission, comprising:
a staging processor for processing a data bitstream to generate a first portion and a second portion thereof;
an encryptor for encrypting the first portion to generate an encrypted first portion;
a combiner for combining the encrypted first portion with the second portion to generate a combined bitstream.

2. The apparatus of claim 1 wherein the staging processor further provides for generating a structured bitstream comprising the first portion and the second portion.

3. The apparatus of claim 1 further comprising an input interface for receiving the data bitstream.

4. The apparatus of claim 1 further comprising an output interface for transmitting the combined bitstream.

5. The apparatus of claim 1 wherein the staging processor further provides for processing a data bitstream comprising a compressed data bitstream.

6. The apparatus of claim 1 further comprising a decoder wherein the decoder provides for:
accessing a partially or a completely compressed data bitstream; and
providing a partially or a completely decompressed data bitstream to the staging processor.

7. The apparatus of claim 1 further comprising a decoder wherein the decoder provides for:
accessing a partially or a completely compressed first portion; and
providing a partially or a completely decompressed first portion to the encryptor.

8. The apparatus of claim 1 further comprising a decoder wherein the decoder provides for:
accessing a partially or a completely compressed second portion; and
providing a partially or a completely decompressed second portion to the encryptor.

9. The apparatus of claim 1 wherein the staging processor further provides for processing a data bitstream comprising protected material.

10. The apparatus of claim 9 wherein the protected material comprises material selected from the group of: copyrighted material, proprietary material, sensitive data, content with digital ownership or material subject to digital rights management (DRM) methodologies.

11. The apparatus of claim 1 wherein the staging processor further provides for processing a data bitstream comprising audio data, audio video data, video data or multimedia data.

12. The apparatus of claim 1 wherein the staging processor further provides for processing a data bitstream to generate a second portion comprising a set of side information, said set of side information comprising information about said data bitstream.

13. The apparatus of claim 1 wherein the staging processor further provides for accessing, calculating or retrieving information to generate a second portion.

14. The apparatus of claim 1 wherein the staging processor further provides for processing a data bitstream to generate a first portion wherein said first portion comprises video block segments.

15. The apparatus of claim 14 wherein the staging processor further provides for processing a data bitstream to generate a second portion wherein said second portion comprises video block headers associated with the video block segments.

16. The apparatus of claim 15 wherein the staging processor further provides for processing a data bitstream to generate a second portion wherein said second portion comprises video block headers associated with the video block segments, the video block headers comprising metadata selected from the group of: a description of the video block segment layout, video block segment offset information, video block segment length data, video block length, video block segment bit rate, video block segment usage value, video block segment compression statistics, video block segment look-ahead packet schedule information, video block segment timestamps, indexing metadata, number of coded pictures before the next intra coded picture and content management metadata.

17. The apparatus of claim 1 further comprising an encoder for partially compressing a combined bitstream.

18. The apparatus of claim 1 further comprising an encoder for completely compressing a combined bitstream.

19. The apparatus of claim 1 further comprising a transrator for changing the bit rate of the first portion.

20. The apparatus of claim 19 wherein the transrator provides for decreasing the bit rate to one or more target bit rates thereby creating an encrypted data bitstream comprising:
multiple versions of the same data bitstream, each version at a different bit rate; and,
a set of side information associated with the encrypted data bitstream.

21. The apparatus of claim 19 further comprising a requantizer for changing the bit rate of the first portion.

22. The apparatus of claim 21 wherein the requantizer further provides for decreasing the bit rate to one or more target bit rates thereby creating an encrypted data bitstream comprising:
multiple versions of the same data bitstream, each version at a different bit rate; and,
a set of side information associated with the encrypted data bitstream.

23. The apparatus of claim 1 further comprising a formatter for formatting the first portion into one or more transport packets.

24. The apparatus of claim 1 further comprising an aligner for aligning the first portion with the second portion in preparation for transmission.

25. The apparatus of claim 1 wherein:
the staging processor provides for generating a multiplicity of first portions, each with a different bit rate;
the encryptor provides for encrypting the multiplicity of first portions to generate a set of encrypted first portions; and,
the combiner provides for combining the set of encrypted first portions with the second portion to generate a combined bitstream.

26. An apparatus for bit rate based processing of encrypted pre-processed data comprising:
an interface for receiving encrypted pre-processed data wherein encrypted pre-processed data comprises:
an encrypted data bitstream comprising multiple versions of the same data bitstream, each version at a different bit rate; and,
a set of side information associated with the encrypted data bitstream; and,
a processor for operating on the encrypted pre-processed data by inspecting the contents of a set of side information without requiring the decryption of the encrypted data bitstream.

27. The apparatus of claim 26 further comprising a statistical multiplexor for multiplexing a portion of the encrypted data bitstream with one or more other bitstreams without requiring the decryption of the encrypted data bitstream by inspecting the contents of the set of side information.

28. The apparatus of claim 26 further comprising a splicer for splicing a portion of the encrypted data bitstream with one or more other bitstreams without requiring the decryption of the encrypted data bitstream by inspecting the contents of the set of side information.

29. The apparatus of claim 26 further comprising a bit rate switcher for multiplexing of the encrypted data bitstream with a one or more other bitstreams without requiring the decryption of the encrypted data bitstream by inspecting the contents of the set of side information.
